(19) United States
(12) Patent Application Publication
(10) Pub. No.: US 2008/0295703 A1
(43) Pub. Date: Dec. 4, 2008

(54) THERMO-MODERATING GRILL FOR A BAKING STONE OF A BARBECUE

(76) Inventor: Chien-Chou Chen, Tainan City (TW)

Correspondence Address: Rabin & Berdo, P.C., Suite 500, 1101 14th Street, Washington, DC, 20005, US

(21) Appl. No.: 11/754,423

(22) Filed: May 29, 2007

(51) Int. Cl. A47J 37/04; A47J 37/07

(52) U.S. Cl. 99/340

(57) ABSTRACT

A thermo-moderating grill for a baking stone for a barbecue has a grill and a thermo-moderating panel. The grill is formed with multiple interlaced metal wires, is adapted to be mounted over a heating chamber, containing a heating device, formed in the barbecue for supporting a baking stone. The thermo-moderating panel is mounted between the grill and the heating device to moderate the heat from the heating device. Therefore, thermal convection of air between the thermo-moderating panel and the baking stone can evenly heat the baking stone to form an even thermal distribution on the baking stone to cook ingredients laid on the baking stone consistently and protect the baking stone from cracks caused by uneven thermal distribution.

### BACKGROUND OF THE INVENTION

1. Field of the Invention

The present invention relates to a thermo-moderating grill for a baking stone of a barbecue, and more particularly to a thermo-moderating grill that can prevent flames from directly heating a baking stone of the barbecue and protect the baking stone from cracks caused by uneven thermal distribution.

2. Description of the Prior Art

A conventional baking stone barbecue in accordance with the present invention has a grill pan, a grill and a baking stone. The grill pan has a heating chamber and a heating device. The heating chamber is formed in the grill pan and has a top opening. The heating device is mounted in the heating chamber to generate heat and may be charcoal, gas hobs, a hot plate or the like. The grill is mounted detachably over the top opening of the heating chamber. The baking stone is placed on the grill to be heated by the heat passing through the grill to cook ingredients laid on the baking stone. The baking stone insulates the ingredients from the heat so that a barbecue can be used to cook food and prevents flames from burning the ingredients and forming distasteful and harmful carcinogens, making barbecuing tastier and healthier than barbecues without the baking stone.

However, this configuration is hard to control, and if the heat forms an uneven thermal distribution on the baking stone food can be over or under cooked or if the heat is too intense, cracks may be formed on the baking stone. Consequently, a life span of the baking stone is severely reduced.

### SUMMARY OF THE INVENTION

The primary objective of the present invention is to provide a thermo-moderating grill for a heat stone of a barbecue to prevent a heat source from over-heating a baking stone of the barbecue to prolong a life span of the baking stone.

The thermo-moderating grill in accordance with the present invention has a grill and a thermo-moderating panel. The grill is adapted to be mounted over a top opening of a heating chamber formed in a grill pan of the barbecue and is used for supporting the baking stone. The grill is formed with multiple interlaced metal wires and has an outer surface. The thermo-moderating panel is mounted under the grill to moderate the heat generated by a heating device mounted in the heating chamber. Therefore, the heating device is prevented from over-heating the baking stone placed on the grill, and the baking stone is evenly heated by thermal convection of air between the thermo-moderating panel and the baking stone. Accordingly, the baking stone is effectively protected from cracks caused by an uneven thermal distribution, and food laid on the baking stone can be cooked consistently and be tasty and healthy.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a barbecue in which a first embodiment of a thermo-moderating grill in accordance with the present invention is mounted;

FIG. 2 is a side view in partial section of the barbecue in FIG. 1;

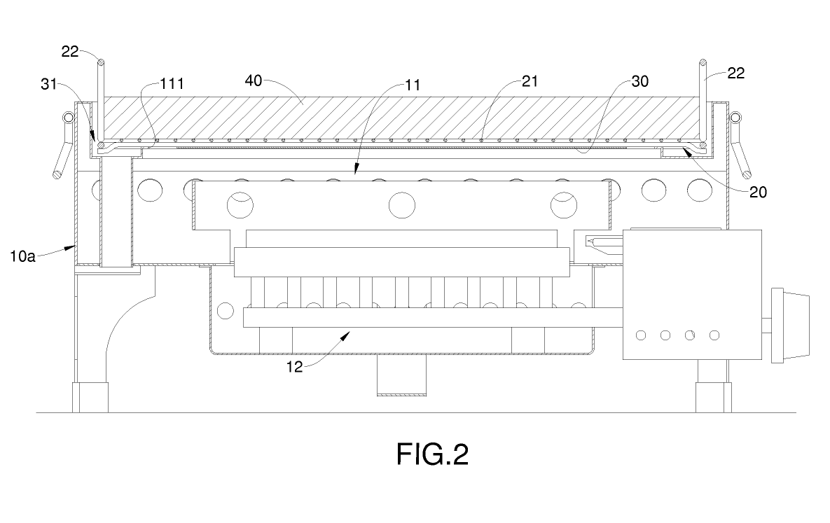

FIG. 3 is a perspective view of the barbecue in FIG. 1;

FIG. 4 is an exploded perspective view of a barbecue in which a second embodiment of a thermo-moderating grill in accordance with the present invention is mounted; and

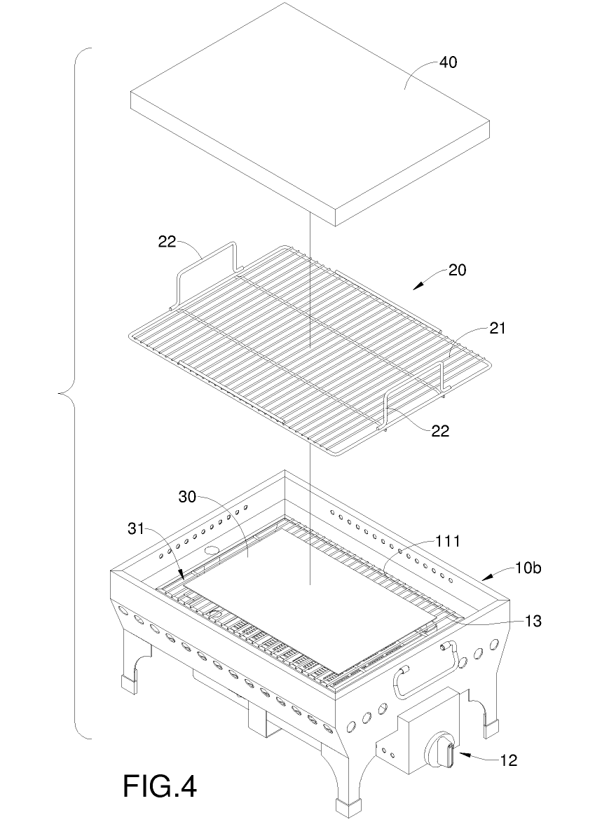

FIG. 5 is a side view in partial section of the barbecue in FIG. 4.

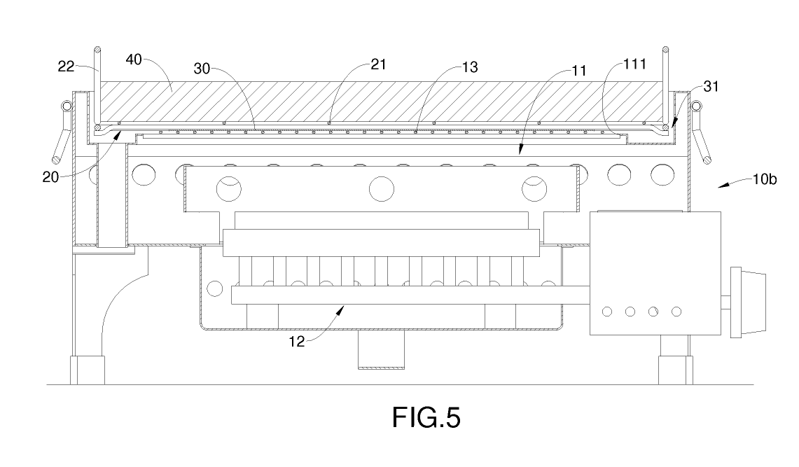

### DETAILED DESCRIPTION OF THE PREFERRED EMBODIMENTS

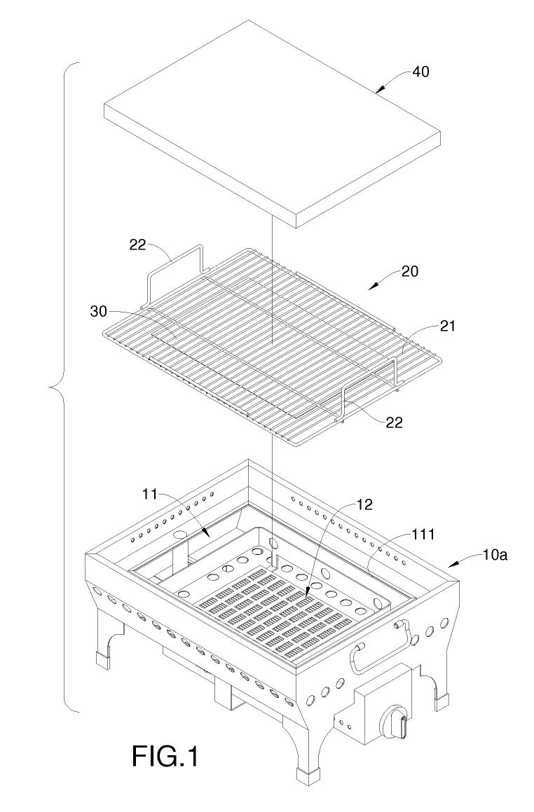

With reference to FIGS. 1,2, 4 and 5, a barbecue comprises a grill pan (10a, 10b), a thermo-moderating grill and a baking stone (40).

The grill pan (10a, 10b) has a heating chamber (11), a heating device (12) and an optional mounting rack (13). The heating chamber (11) is formed in the grill pan (10a, 10b) and has a top opening (111). The top opening (111) of the heating chamber (11) has an inner edge. The heating device (12) is mounted in the heating chamber (11) to generate heat and may be charcoal, gas hobs, electric coils, a hot plate or the like. The mounting rack (13) is mounted in the top opening (111) of the heating chamber (11), is formed with multiple interlaced metal wires and has an outer edge. The outer edge of the mounting rack (13) may be mounted securely on the inner edge of the top opening (111) of the heating chamber (11).

The thermo-moderating grill in accordance with the present invention is mounted over the top opening (111) of the heating chamber (11) and comprises a grill (20) and a thermo-moderating panel (30). The grill (20) is mounted detachably over the top opening (111) of the heating chamber (11), is formed with multiple interlaced metal wires (21) and has a bottom, an outer edge and two optional handles (22). The handles (22) are diametrically formed on and protrude vertically away from the outer edge of the grill (20), allowing a person to lift the grill (20).

The thermo-moderating panel (30) is mounted adjacent to the bottom of the grill (20), forms a circumferential vent (31) between the thermo-moderating panel and the inner edge of the heating chamber (11) and may be implemented in several ways. The thermo-moderating panel (30) is heated by the heating device (12) in the heating chamber (11) and prevents flames from passing through the grill (20). Air heated in the heating chamber (11) escapes from the vent (31).

In a first implementation of the thermo-moderating panel (30), the thermo-moderating panel (30) is attached securely to the bottom of the grill (20) by welds, fasteners or such like.

In a second implementation of the thermo-moderating panel (30), the thermo-moderating panel (30) is attached securely on the mounting rack (13) by welds, fasteners or the like and the grill (20) is detachably mounted above the thermo-moderating panel.

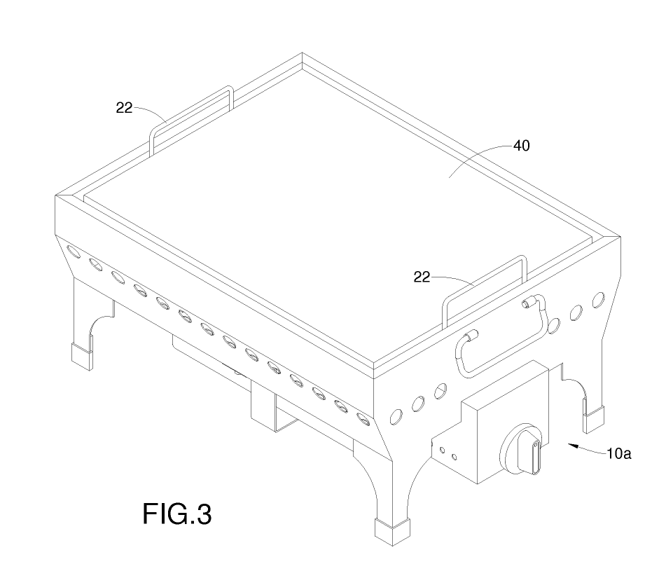

With further reference to FIG. 3, the baking stone (40) is placed on the grill (30). The heat in the heating chamber (11) is insulated from the baking stone (40) by the thermo-moderating panel (30), so that the baking stone (40) is protected from being over heated by the heating device (12). The baking stone (40) is evenly heated by thermal convection of air between the thermo-moderating panel (30) and the baking stone (40). Accordingly, an even thermal distribution on the baking stone (40) causes food laid on the baking stone (40) to cook consistently and be tasty and healthy. Additionally, the baking stone (40) is protected from cracks caused by an uneven thermal distribution to increase a life span.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A thermo-moderating grill for a baking stone of a barbecue comprising:
a grill being formed with multiple interlaced metal wires and having a bottom and an outer edge; and
a thermo-moderating panel being mounted adjacent to the bottom of the grill.

2. The thermo-moderating grill as claimed in claim 1, wherein the thermo-moderating panel is attached securely to the bottom of the grill.

3. The thermo-moderating grill as claimed in claim 1 wherein, the grill further comprises two handles being diametrically formed on and protruding vertically from the outer edge of the grill.

4. The thermo-moderating grill as claimed in claim 2, wherein the grill further comprises two handles being diametrically formed on and protruding vertically from the outer edge of the grill.

5. A barbecue comprising:
a grill pen having
a heating chamber being formed in the grill pan and having a top opening having an inner edge; and
a heating device being mounted in the heating chamber;
a thermo-moderating grill being mounted over the top opening of the heating chamber and having
a grill being mounted detachably over the top opening of the heating chamber, formed with multiple interlaced metal wires and having a bottom and an outer edge; and
a thermo-moderating panel being mounted adjacent to the bottom of the grill and forming a circumferential vent between the thermo-moderating panel and the inner edge of the heating chamber; and
a baking stone being placed on the grill.

6. The barbecue as claimed in claim 5, wherein the thermo-moderating panel is attached securely to the bottom of the grill.

7. The barbecue as claimed in claim 5, wherein
the grill pen further has a mounting rack being mounted in the top opening of the heating chamber, formed with multiple interlaced metal wires and having an outer edge; and
the thermo-moderating panel is attached securely on the mounting rack.

8. The barbecue as claimed in claim 7, wherein the outer edge of the mounting rack is mounted securely on the inner edge of the top opening of the heating chamber.

9. The barbecue as claimed in claim 5 wherein, the grill further comprises two handles being diametrically formed on and protruding vertically from the outer edge of the grill.

10. The barbecue as claimed in claim 6 wherein, the grill further comprises two handles being diametrically formed on and protruding vertically from the outer edge of the grill.

11. The barbecue as claimed in claim 7 wherein, the grill further comprises two handles being diametrically formed on and protruding vertically from the outer edge of the grill.

12. The barbecue as claimed in claim 8 wherein, the grill further comprises two handles being diametrically formed on and protruding vertically from the outer edge of the grill.
